(19) United States
(12) Patent Application Publication
(10) Pub. No.: US 2025/0291802 A1
(43) Pub. Date: Sep. 18, 2025

(54) MEMORY MANAGEMENT DEVICE AND MEMORY MANAGEMENT METHOD

(71) Applicant: MEDIATEK INC., Hsinchu City (TW)

(72) Inventors: Yu-Ting WAN, Hsinchu City (TW); Po-Yuan JENG, Hsinchu City (TW); Lei CHEN, Hsinchu City (TW); Hung-Chun LIU, Hsinchu City (TW); Yu-Chieh LIN, Hsinchu City (TW)

(21) Appl. No.: 19/076,157

(22) Filed: Mar. 11, 2025

Related U.S. Application Data
(60) Provisional application No. 63/564,526, filed on Mar. 13, 2024.

(51) Int. Cl. G06F 16/2455; G06F 12/14

(52) U.S. Cl. CPC G06F 16/24558; G06F 12/1458; G06F 16/24562

(57) ABSTRACT

A memory management method is provided. The method includes a memory allocation stage and an address resolution stage. The memory allocation stage includes receiving a memory allocation request from the application program, allocating a buffer with the specified size in the memory in response to the memory allocation request, and generating a buffer pointer for the buffer, and return the buffer pointer to the application program. The buffer is a device buffer is allocated for one or more accelerator devices, or a CPU buffer allocated for a CPU. The address resolution stage includes receiving a memory access request from the application program, determining whether the search pointer corresponds to the device buffer or the CPU buffer based on the buffer pointer and the specified size, allowing access to the corresponding device buffer or CPU buffer.

### CROSS REFERENCE TO RELATED APPLICATIONS

This application claims the benefit of U.S. Provisional Application No. 63/564,526, filed Mar. 13, 2024, the entirety of which is incorporated by reference herein.

### BACKGROUND OF THE INVENTION

### Field of the Invention

The present invention relates to memory management techniques, and, in particular, to a memory management device and memory management method.

### Description of the Related Art

In modern computing systems, various processing devices, such as central processing units (CPUs), graphics processing units (GPUs), and domain-specific accelerators (e.g., neural processing units (NPUs) and vision processing units (VPUs)), require efficient memory access to perform computational tasks. To improve performance, data is often stored in device memory, reducing data transfer latency and offloading memory operations from the CPU. However, different types of buffers, such as CPU buffer and Direct Memory Access (DMA) buffer, may have different access mechanisms, making memory management complex for software developers.

For instance, when accessing a DMA buffer, developers typically need to handle multiple parameters, including a file descriptor of the DMA buffer, the base address of the buffer, and an offset value. In contrast, a CPU buffer can often be accessed directly through a pointer. These inconsistencies in memory access interfaces across different devices increase programming complexity and reduce software portability.

Additionally, some device memory regions (e.g., some device buffers) may have restricted access due to security concerns. Certain proprietary accelerators may not allow direct memory access from application space to prevent erroneous operations that could lead to system failures or security vulnerabilities. This further complicates memory management in heterogeneous computing environments.

Therefore, a memory management device and a memory management method are needed to provide a unified approach for managing different types of memory regions.

### BRIEF SUMMARY OF THE INVENTION

An embodiment of the present disclosure provides a memory management device. The memory management device includes a processor and a non-transitory computer-readable storage. The non-transitory computer-readable storage is coupled to the processor, and is configured to store a memory management program including instructions that, when executed by the processor, cause the processor to perform an execution of an allocator module and an execution of a resolver module. The execution of the allocator module causes the processor to receive a memory allocation request including a specified size from an application program, allocate a buffer with the specified size in a memory in response to the memory allocation request, and generate a buffer pointer for the buffer, and return the buffer pointer to the application program. The buffer is a device buffer allocated for one or more accelerator devices, or a CPU buffer allocated for a CPU. The execution of the resolver module causes the processor to receive a memory access request including a search pointer from the application program, determine, based on the buffer pointer and the specified size, whether the search pointer corresponds to the device buffer or the CPU buffer, and allow access to the device buffer if the search pointer corresponds to the device buffer, and allow access to the CPU buffer if the search pointer corresponds to the CPU buffer.

In an embodiment, the execution of the allocator module further causes the processor to store, in a data structure, mapping entries between a plurality of the buffer pointers of device buffers, the device buffers, and the specified sizes associated with the device buffers. The execution of the resolver module further causes the processor to check whether the data structure contains at least one mapping entry, and determine that the search pointer corresponds to the CPU buffer if the data structure does not contain any mapping entry. The execution of the resolver module further causes the processor to identify, from the data structure, the largest one of the buffer pointers that is not larger than the search pointer included in the memory access request if the data structure contains at least one mapping entry. The execution of the resolver module further causes the processor to determine that the search pointer corresponds to the device buffer if the search pointer is not larger than the sum of the identified buffer pointer and the specified size associated with the identified buffer pointer, and determine that the search pointer corresponds to the CPU buffer otherwise.

In an embodiment, the data structure is constructed as a red-black tree, and the execution of the resolver module further causes the processor to perform a binary search on the red-black tree to identify the largest one of the buffer pointers that is not larger than the search pointer included in the memory access request.

In an embodiment, he execution of the resolver module further causes the processor to determine whether the memory access request is issued by a process that is authorized to access the buffer, and deny access to the buffer if the memory access request is determined to be issued by an unauthorized process.

In an embodiment, the buffer pointer indicates the starting address of the buffer, the ending address of the buffer, or the offset address corresponding to a fix location of the buffer. The search pointer indicates a memory address requested by the application program.

In an embodiment, the device buffer includes a graphics processing unit (GPU) buffer, a neural processing unit (NPU) buffer, a vision processing unit (VPU) buffer, a direct memory access (DMA) buffer, or a deep learning accelerator (DLA) buffer. Each of the one or more accelerator devices comprises a GPU, an NPU, a VPU, a DMA, or a DLA.

Another embodiment of the present disclosure provides a memory management device. The memory management device includes an allocator circuit and a resolver circuit. The allocator circuit is configured to receive a memory allocation request including a specified size from an application program, allocate a buffer with the specified size in a memory in response to the memory allocation request, and generate a buffer pointer for the buffer, and return the buffer pointer to the application program. The buffer is a device buffer allocated for one or more accelerator devices, or a CPU buffer allocated for a CPU. The resolver circuit is configured to receive a memory access request including a search pointer from the application program, determine, based on the buffer pointer and the specified size, whether the search pointer corresponds to the device buffer or the CPU buffer, and allow access to the device buffer if the search pointer corresponds to the device buffer, and allow access to the CPU buffer if the search pointer corresponds to the CPU buffer.

In an embodiment, the allocator circuit is further configured to store, in a data structure, mapping entries between a plurality of the buffer pointers of device buffers, the device buffers, and the specified sizes associated with the device buffers. The resolver circuit is configured to check whether the data structure contains at least one mapping entry, and determine that the search pointer corresponds to the CPU buffer if the data structure does not contain any mapping entry. The resolver circuit is further configured to identify, from the data structure, the largest one of the buffer pointers that is not larger than the search pointer included in the memory access request. The resolver circuit is further configured to determine that the search pointer corresponds to the device buffer if the search pointer is not larger than the sum of the identified buffer pointer and the specified size associated with the identified buffer pointer, and determine that the search pointer corresponds to the CPU buffer otherwise.

In an embodiment, the data structure is constructed as a red-black tree, and the resolver circuit is further configured to perform a binary search on the red-black tree to identify the largest one of the buffer pointers that is not larger than the search pointer included in the memory access request.

In an embodiment, the resolver circuit is further configured to determine whether the memory access request is issued by a process that is authorized to access the device buffer, and deny access to the device buffer if the memory access request is determined to be issued by an unauthorized process.

Another embodiment of the present disclosure provides a memory management method. The method includes a memory allocation stage and an address resolution stage. The memory allocation stage includes receiving a memory allocation request from the application program, allocating a buffer with the specified size in the memory in response to the memory allocation request, and generating a buffer pointer for the buffer, and return the buffer pointer to the application program. The buffer is a device buffer is allocated for one or more accelerator devices, or a CPU buffer allocated for a CPU. The address resolution stage includes receiving a memory access request from the application program, determining whether the search pointer corresponds to the device buffer or the CPU buffer based on the buffer pointer and the specified size, allowing access to the corresponding device buffer or CPU buffer.

Embodiments of the memory management device and memory management method provided herein address the challenges of managing heterogeneous memory access by introducing a unified approach for allocating and resolving memory addresses. By efficiently handling memory allocation requests and storing mapping entries between buffer pointers and device buffers, the disclosed techniques simplify memory access across different processing devices. The use of a structured data organization, such as a red-black tree, enables fast address resolution through binary search, reducing lookup latency and improving scalability. Compared to conventional approaches that require device-specific memory access mechanisms, the disclosed embodiments improve software portability, reduce programming complexity, and optimize memory access efficiency in heterogeneous computing environments.

### BRIEF DESCRIPTION OF THE DRAWINGS

The present invention can be more fully understood by reading the subsequent detailed description and examples with references made to the accompanying drawings, wherein:

FIG. 1A is a flow diagram depicting the steps of the memory management method, according to an embodiment of the present disclosure;

FIG. 1B is a system architecture diagram that illustrates the interaction among various components involved in the memory management method;

FIG. 2 is a flow diagram illustrating a detailed process for determining whether the search pointer corresponds to the device buffer or the CPU buffer in the address resolution stage, according to an embodiment of the present disclosure;

FIGS. 3A to 3C are schematic diagrams illustrating different cases of determining whether a search pointer corresponds to the device buffer or the CPU buffer, according to an embodiment of the present disclosure;

FIG. 4 is a block diagram of a memory management device, according to an embodiment of the present disclosure; and

FIG. 5 is a block diagram of a memory management device 50, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

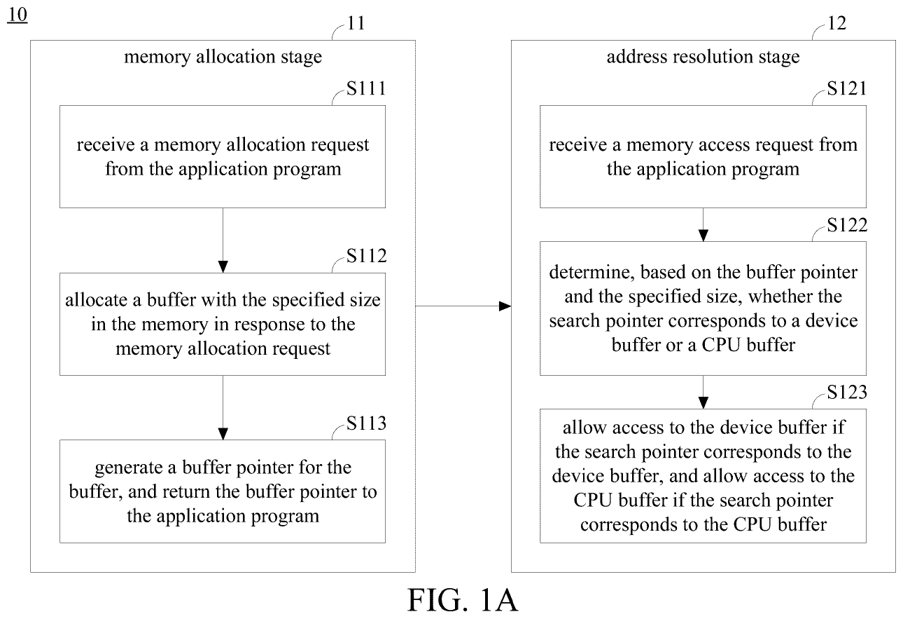

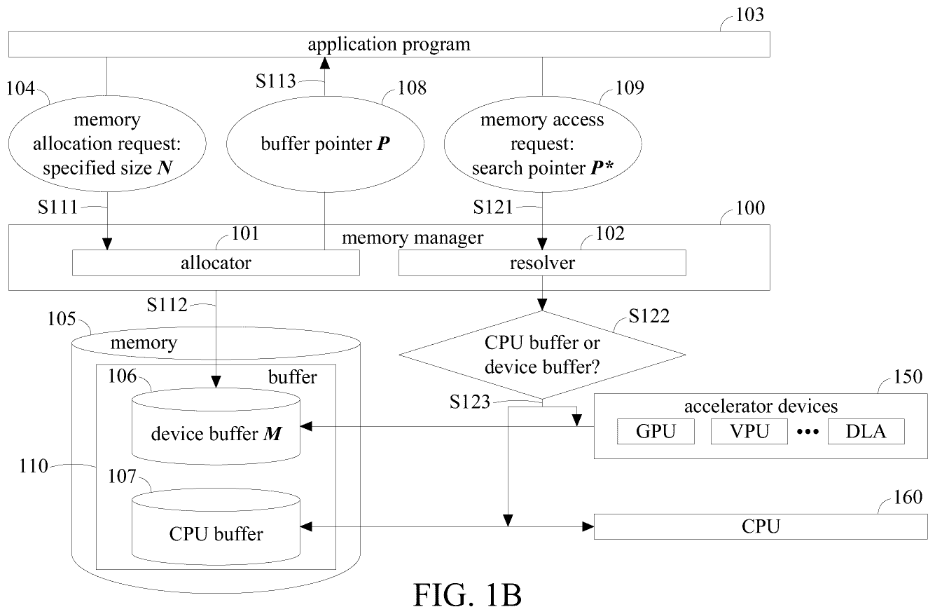

FIG. 1A is a flow diagram depicting the steps of the memory management method 10, according to an embodiment of the present disclosure. As shown in FIG. 1A, the memory management method 10 includes a memory allocation stage 11 and an address resolution stage 12. The memory allocation stage 11 includes steps S111-S113, while the address resolution stage 12 includes steps S121-S123. FIG. 1B is a corresponding system architecture diagram that illustrates the interaction among various components involved in the memory management method 10. To better understand the embodiment, FIG. 1A and FIG. 1B should be referenced together.

The memory management method 10 illustrated in FIG. 1A is executed by the memory manager 100 illustrated in FIG. 1B. The memory manager 100 further includes an allocator 101 and a resolver 102. The memory allocation stage 11 and the address resolution stage 12 are executed by the allocator 101 and the resolver 102, respectively.

In step S111, the allocator 101 receives a memory allocation request 104 from the application program 103. The memory allocation request 104 includes a specified size N, indicating the amount of memory required by the application program 103.

In step S112, in response to the memory allocation request 104, the allocator 101 allocates a buffer 110 in the memory 105 with the specified size N. The buffer 110 may be a device buffer 106 allocated for one or more accelerator devices 150, which may include but not limited to graphics processing units (GPUs), neural processing units (NPUs), vision processing units (VPUs), DMAs, and deep learning accelerators (DLAs). Additionally, the buffer 110 also could be a CPU buffer 107 allocated for CPU 160. In some embodiments, the device buffer 106 may be a GPU buffer, a VPU buffer, a DMA buffer, a DLA buffer, etc. More generally, the accelerator devices 150 in a computer system may include any device distinct from the CPU. In some embodiments, memory 105 is system memory, e.g., a Random Access Memory (RAM) of a computer system, and the device buffer 106 and the CPU buffer 107 share the regions of the system memory. In some embodiments, memory 105 may comprise more than one hardware memories located in different hardware device, for example, memory 105 may comprise a system memory, and a region of the system memory can be allocated as a CPU buffer 107 for the CPU, memory 105 may also comprise a Video Random Access Memory (VRAM), and a region of the VRAM can be allocated as a GPU buffer (which is a device buffer 106) for the GPU.

In step S113, the allocator 101 generates a buffer pointer 108 P for the buffer 110 and returns the buffer pointer 108 P to the application program 103. The buffer pointer 108 P serves as a unified address pointer that facilitates the application program 103 to access the buffer 110 in a consistent manner. In some embodiments, the buffer pointer 108 indicates the starting address of an allocated buffer 110. In some other embodiments, the buffer pointer 108 indicates an ending address of an allocated buffer 110. In some other embodiments, the buffer pointer 108 indicates an offset address corresponds to a fix location (e.g., the starting address, a middle address, or the ending address) of an allocated buffer 110.

In step S121, the resolver 102 receives a memory access request 109 from the application program 103. The memory access request 109 includes a search pointer P*, which indicates a memory address requested by the application program 103 for data access. For instance, in a neural network inference process, the search pointer P* may correspond to the memory location storing input feature maps, intermediate tensors, or model weights required for computation.

In step S122, the resolver 102 determines whether the search pointer P* corresponds to the device buffer 106 or the CPU buffer 107 based on the buffer pointer 108 and the specified size N. Specifically, if the resolver 102 determines that the search pointer P* falls within the address range of the device buffer 106, it is determined that the search pointer P* corresponds to the device buffer 106. Otherwise, the search pointer P* corresponds to the CPU buffer 107.

In step S123, the resolver 102 allows the application program 103 to access the corresponding memory region. Specifically, if the search pointer P* corresponds to the device buffer 106, access to the device buffer 106 is granted, for example, may allow the accelerator devices 150 or the CPU 160 to read or write data in device buffer 106 through the application program 103. If the search pointer P* corresponds to the CPU buffer 107, access to the CPU buffer 107 is granted, for example, enabling the CPU 160 or the accelerator devices 150 to read or write data in CPU buffer 106 relating to the CPU 160 through the application program 103.

It should be noted that, although FIG. 1B illustrates only a single device buffer 106, in practical implementations, multiple sections of the memory 105 may be allocated as device buffers in response to different memory allocation requests. Each allocated device buffer is associated with a distinct buffer pointer, allowing the application program 103 to reference and access different memory regions as needed. As a result, the memory manager 100 may maintain multiple buffer pointers, each corresponding to a separately allocated device buffer or CPU buffer, along with its respective specified size.

In an embodiment, the memory allocation stage 11 further includes storing, in a data structure, mapping entries between buffer pointers of device buffers, the device buffers, and the specified sizes associated with the device buffers. The data structure may be implemented as <key, value> pairs, a lookup table, a linked list, or a tree-based structure, allowing efficient searching and retrieval of buffer information, but the present disclosure is not limited thereto. In some embodiments, the data structure may comprise a plurality of mapping entries, and each mapping entry is a mapping between a buffer pointer of a device buffer, the device buffer, and the specified size associated with the device buffer. In an implementation, a mapping entry may be represented as a <key, value> pair, where the buffer pointer 108 (denoted as P) serves as the key, and the corresponding device buffer 106 (denoted as M) and the specified size N form the value, i.e., the <key, value> pair may be <P, <M, N>>. This mapping enables the resolver 102 to efficiently resolve memory access requests for device buffer 106.

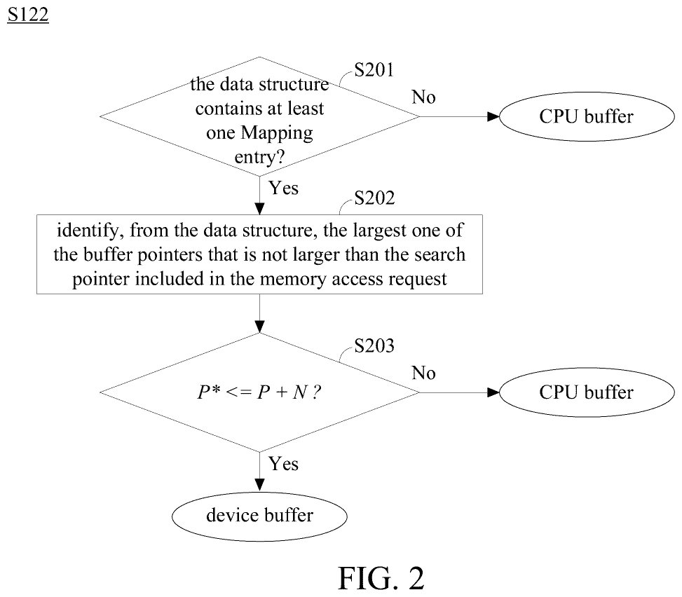

Additionally, step S122 utilizes this data structure to determine whether the search pointer corresponds to the device buffer or the CPU buffer. More detailed steps regarding this process will be described hereinafter with reference to FIG. 2, which expands on step S122 of FIG. 1A.

FIG. 2 is a flow diagram illustrating a detailed process for determining whether the search pointer corresponds to the device buffer or the CPU buffer in the address resolution stage, according to an embodiment of the present disclosure. As shown in FIG. 2, this process, namely the step S122 of FIG. 1A, further includes steps S201-S203.

In step S201, the resolver 102 checks whether the data structure contains at least one mapping entry. For example, the resolver 102 checks whether the size of the data structure is non-zero. As described earlier, the data structure stores mapping entries between buffer pointers of device buffers, device buffers, and their respective specified sizes. Each mapping entry in the data structure may be a mapping between a buffer pointer of a device buffer, the device buffer (e.g., an ID), and a specified size of the device buffer. If the data structure does not contain any entries, meaning no device buffers have been allocated, the resolver 102 determines that the search pointer corresponds to the CPU buffer, and the process terminates. Otherwise, the process proceeds to step S202.

In step S202, the resolver 102 identifies, from the data structure, the largest one of the buffer pointers that is not larger than the search pointer P* included in the memory access request 109. The identified buffer pointer serves as a reference for determining whether the search pointer falls within the allocated range of a device buffer. This step ensures that the resolver 102 selects the closest preceding buffer pointer relative to the search pointer P*.

In step S203, the resolver 102 determines whether the search pointer is within the range of the device buffer associated with the identified buffer pointer. Specifically, the resolver 102 checks whether the search pointer is less than or equal to the sum of the identified buffer pointer and the specified size associated with that buffer pointer. If this condition is satisfied, the search pointer P* corresponds to the device buffer, and access is granted accordingly. Otherwise, the resolver 102 determines that the search pointer P* corresponds to the CPU buffer.

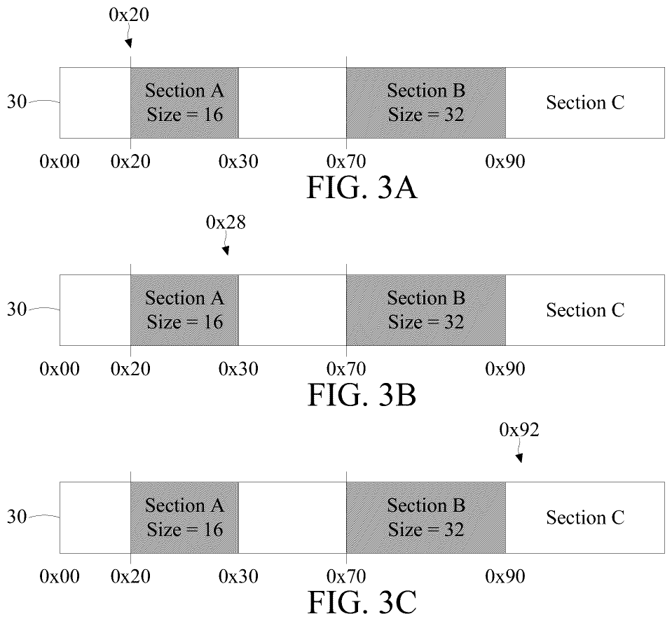

FIGS. 3A to 3C are schematic diagrams illustrating different cases of determining whether a search pointer corresponds to a device buffer or the CPU buffer, according to some embodiments of the present disclosure. These three cases represent various scenarios in which a search pointer is evaluated based on the stored buffer pointers and their associated allocated sizes in the data structure.

FIG. 3A illustrates a case where the search pointer directly points to the starting address of an allocated device buffer. In FIG. 3A, the search pointer is 0x20, which exactly matches the starting address indicated by the identified largest buffer pointer of a device buffer, e.g., Section A of the memory 30. Wherein, the device buffer (e.g., Section A) has a size of 16 bytes. Since the search pointer is within the address range of Section A (from 0x20 to 0x30), it is determined that the search pointer corresponds to the device buffer.

FIG. 3B illustrates a case where the search pointer is within the allocated range of a device buffer. In FIG. 3B, the search pointer is 0x28, which falls within the range of Section A (0x20 to 0x30). For example, the resolver identifies the largest buffer pointer that is not larger than 0x28 is 0x20, and checks whether the search pointer is within the allocated size of Section A. Since 0x28≤0x20+16, the search pointer is determined to correspond to the device buffer.

FIG. 3C illustrates a case where the search pointer falls outside the allocated device buffer regions, resulting in a default mapping to the CPU buffer. In FIG. 3C, the search pointer is 0x92, which does not fall within the range of any allocated device buffer. In this embodiment, the resolver identifies the largest buffer pointer that is not larger than 0x92 is 0x70 (corresponding to Section B). However, since 0x92>0x70+32, the search pointer does not correspond to any device buffer, and it is determined that the search pointer corresponds to the CPU buffer.

In an embodiment, the above-described data structure (e.g., the <key, value> pairs) is constructed as a red-black tree, and the largest one of the buffer pointers that is not larger than the search pointer included in the memory access request is identified by performing a binary search on the red-black tree. A red-black tree is a type of self-balancing binary search tree that maintains a balanced structure by enforcing specific color-based properties during insertion and deletion operations. These properties ensure that the tree remains approximately balanced, keeping the height at O(log n), where n is the number of nodes in the tree. By using a red-black tree to store mappings between buffer pointers and device buffers, the resolver can efficiently identify the largest buffer pointer that is not larger than the search pointer through binary search, which operates in O(log n) time complexity. Binary search works by iteratively comparing the search pointer against the buffer pointers stored in the tree and navigating left or right based on the comparison results. This approach ensures that the lookup operation is performed in logarithmic time, significantly reducing the overhead of address resolution compared to an unstructured or linear search approach.

In an embodiment, the address resolution stage further includes determining whether the memory access request is issued by a process that is authorized to access the device buffer or CPU buffer, and denying access to the device buffer or CPU buffer if the memory access request is determined to be issued by an unauthorized process. To ensure secure memory access, the resolver may maintain an access control list (ACL) or use process authentication mechanisms to verify whether the requesting process has the necessary permissions to access the device buffer or CPU buffer. This verification can be performed by checking process identifiers (PIDs), security tokens, or cryptographic authentication keys associated with the memory access request. By incorporating access control into the address resolution stage, the system can prevent unauthorized access, reducing the risk of unintended memory corruption, data leaks, or malicious attacks. This security measure is particularly important in multi-process environments or shared computing platforms, where different applications or processes may request access to the same memory regions. Denying access to unauthorized processes helps maintain data integrity and ensures that memory resources are securely managed across multiple computing devices.

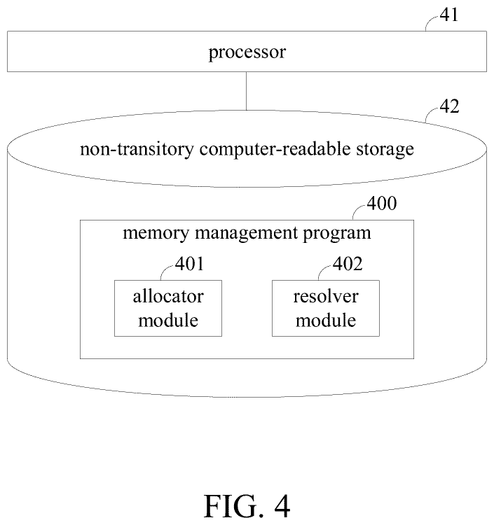

FIG. 4 is a block diagram of a memory management device 40, according to an embodiment of the present disclosure. As shown in FIG. 4, the memory management device 40 includes a processor 41 and a non-transitory computer-readable storage 42. The non-transitory computer-readable storage 42 may include flash memory, solid-state drives (SSDs), hard disk drives (HDDs), or other storage media, but the present disclosure is not limited thereto. The non-transitory computer-readable storage 42 stores a memory management program 400, which may be implemented using various programming languages, including but not limited to C, C++, Python, Java, or assembly languages, and may be executed as part of an operating system, a device driver, or an application-level library. The memory management program 400 corresponds to the memory manager 100 in FIG. 1B, and it includes instructions that, when executed by the processor, cause the processor 41 to execute the allocator module 401 and the resolver module 402. The allocator module 401 corresponds to the allocator 101 in FIGS. 1B and 1s responsible for handling memory allocation requests, allocating buffers (including device buffers and CPU buffer), generating buffer pointers, and returning buffer pointers to the application. The resolver module 402 corresponds to the resolver 102 in FIGS. 1B and 1s responsible for processing memory access requests by determining whether a given search pointer corresponds to a device buffer or the CPU buffer.

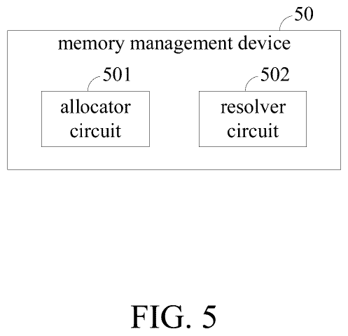

FIG. 5 is a block diagram of a memory management device 50, according to another embodiment of the present disclosure. The memory management device 50 is implemented as hardware circuitry and includes an allocator circuit 501 and a resolver circuit 502, which may be implemented using dedicated hardware logic, such as application-specific integrated circuits (ASICs), field-programmable gate arrays (FPGAs), or system-on-chip (SoC) designs, to optimize memory allocation and address resolution operations. The allocator circuit 501 is configured to handle memory allocation requests by allocating buffers (including device buffers and CPU buffer), generating buffer pointers, and returning the buffer pointers to the application, corresponding to the allocator 101 in FIG. 1B. The resolver circuit 502 is responsible for processing memory access requests by determining whether a given search pointer corresponds to a device buffer or a CPU buffer, corresponding to the resolver 102 in FIG. 1B.

Embodiments of the memory management device and memory management method provided herein address the challenges of managing heterogeneous memory access by introducing a unified approach for allocating and resolving memory addresses. By efficiently handling memory allocation requests and storing mappings between buffer pointers and buffers, the disclosed techniques simplify memory access. The use of a structured data organization, such as a red-black tree, enables fast address resolution through binary search, reducing lookup latency and improving scalability. Compared to conventional approaches that require device-specific memory access mechanisms, the disclosed embodiments improve software portability, reduce programming complexity, and optimize memory access efficiency in heterogeneous computing environments.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory management device, comprising:
a processor; and
a non-transitory computer-readable storage, coupled to the processor, and configured to store a memory management program comprising instructions that, when executed by the processor, cause the processor to perform an execution of an allocator module and an execution of a resolver module;
wherein the execution of the allocator module causes the processor to:
receive a memory allocation request from an application program, wherein the memory allocation request includes a specified size,
allocate a buffer with the specified size in a memory in response to the memory allocation request, and
generate a buffer pointer for the buffer, and return the buffer pointer to the application program,
wherein the buffer is a device buffer allocated for one or more accelerator devices, or a CPU buffer allocated for a CPU; and
wherein the execution of the resolver module causes the processor to:
receive a memory access request from the application program, wherein the memory access request includes a search pointer,
determine, based on the buffer pointer and the specified size, whether the search pointer corresponds to the device buffer or the CPU buffer, and
allow access to the device buffer if the search pointer corresponds to the device buffer, and allow access to the CPU buffer if the search pointer corresponds to the CPU buffer.

2. The memory management device as claimed in claim 1, wherein the execution of the allocator module further causes the processor to store, in a data structure, mapping entries between a plurality of the buffer pointers of device buffers, the device buffers, and the specified sizes associated with the device buffers; and
wherein the execution of the resolver module further causes the processor to:
check whether the data structure contains at least one mapping entry, and determine that the search pointer corresponds to the CPU buffer if the data structure does not contain any mapping entry;
identify, from the data structure, a largest one of the buffer pointers that is not larger than the search pointer included in the memory access request if the data structure contains at least one mapping entry, and
determine that the search pointer corresponds to the device buffer if the search pointer is not larger than a sum of the identified buffer pointer and the specified size associated with the identified buffer pointer, and determine that the search pointer corresponds to the CPU buffer otherwise.

3. The memory management device as claimed in claim 2, wherein the data structure is constructed as a red-black tree, and the execution of the resolver module further causes the processor to perform a binary search on the red-black tree to identify the largest one of the buffer pointers that is not larger than the search pointer included in the memory access request.

4. The memory management device as claimed in claim 1, wherein the execution of the resolver module further causes the processor to determine whether the memory access request is issued by a process that is authorized to access the buffer, and deny access to the buffer if the memory access request is determined to be issued by an unauthorized process.

5. The memory management device as claimed in claim 1, wherein the buffer pointer indicates a starting address of the buffer, an ending address of the buffer, or an offset address corresponding to a fix location of the buffer; and
wherein the search pointer indicates a memory address requested by the application program.

6. The memory management device as claimed in claim 1, wherein the device buffer comprises a graphics processing unit (GPU) buffer, a neural processing unit (NPU) buffer, a vision processing unit (VPU) buffer, a direct memory access (DMA) buffer, or a deep learning accelerator (DLA) buffer; and
each of the one or more accelerator devices comprises a GPU, an NPU, a VPU, a DMA, or a DLA.

7. A memory management device, comprising:
an allocator circuit, configured to:
receive a memory allocation request from an application program, wherein the memory allocation request includes a specified size,
allocate a buffer with the specified size in a memory in response to the memory allocation request, and
generate a buffer pointer for the buffer, and return the buffer pointer to the application program,
wherein the buffer is a device buffer allocated for one or more accelerator devices, or a CPU buffer allocated for a CPU; and
a resolver circuit, configured to:
receive a memory access request from the application program, wherein the memory access request includes a search pointer,
determine, based on the buffer pointer and the specified size, whether the search pointer corresponds to the device buffer or the CPU buffer, and
allow access to the device buffer if the search pointer corresponds to the device buffer, and allow access to the CPU buffer if the search pointer corresponds to the CPU buffer.

8. The memory management device as claimed in claim 7, wherein the allocator circuit is further configured to store, in a data structure, mapping entries between a plurality of the buffer pointers of device buffers, the device buffers, and the specified sizes associated with the device buffers; and
wherein the resolver circuit is further configured to:
check whether the data structure contains at least one mapping entry, and determine that the search pointer corresponds to the CPU buffer if the data structure does not contain any mapping entry;
identify, from the data structure, a largest one of the buffer pointers that is not larger than the search pointer included in the memory access request, and
determine that the search pointer corresponds to the device buffer if the search pointer is not larger than a sum of the identified buffer pointer and the specified size associated with the identified buffer pointer, and determine that the search pointer corresponds to the CPU buffer otherwise.

9. The memory management device as claimed in claim 8, wherein the data structure is constructed as a red-black tree, and the resolver circuit is further configured to perform a binary search on the red-black tree to identify the largest one of the buffer pointers that is not larger than the search pointer included in the memory access request.

10. The memory management device as claimed in claim 7, wherein the resolver circuit is further configured to determine whether the memory access request is issued by a process that is authorized to access the device buffer, and deny access to the device buffer if the memory access request is determined to be issued by an unauthorized process.

11. The memory management device as claimed in claim 7, wherein the buffer pointer indicates a starting address of the buffer, an ending address of the buffer, or an offset address corresponding to a fix location of the buffer; and
wherein the search pointer indicates a memory address requested by the application program.

12. The memory management device as claimed in claim 7, wherein the device buffer comprises a graphics processing unit (GPU) buffer, a neural processing unit (NPU) buffer, a vision processing unit (VPU) buffer, a direct memory access (DMA) buffer, or a deep learning accelerator (DLA) buffer; and
each of the one or more accelerator devices comprises a GPU, an NPU, a VPU, a DMA, or a DLA.

13. A memory management method, applied in a computer system executing an application program, the method comprising:
a memory allocation stage, comprising:
receiving a memory allocation request from the application program, wherein the memory allocation request includes a specified size,
allocating a buffer with the specified size in a memory in response to the memory allocation request; and
generating a buffer pointer for the buffer, and return the buffer pointer to the application program;
wherein the buffer is a device buffer allocated for one or more accelerator devices, or a CPU buffer allocated for a CPU;
an address resolution stage, comprising:
receiving a memory access request from the application program, wherein the memory access request includes a search pointer,
determining, based on the buffer pointer and the specified size, whether the search pointer corresponds to the device buffer or the CPU buffer, and
allowing access to the device buffer if the search pointer corresponds to the device buffer, and allow access to the CPU buffer if the search pointer corresponds to the CPU buffer.

14. The memory management method as claimed in claim 13, wherein the memory allocation stage further comprises storing, in a data structure, mapping entries between a plurality of the buffer pointers of device buffers, the device buffers, and the specified sizes associated with the device buffers;
wherein determining whether the search pointer corresponds to the device buffer or the CPU buffer in the address resolution stage further comprises:
checking whether the data structure contains at least one mapping entry, and determine that the search pointer corresponds to the CPU buffer if the data structure does not contain any mapping entry;
identifying, from the data structure, a largest one of the buffer pointers that is not larger than the search pointer included in the memory access request, and
determining that the search pointer corresponds to the device buffer if the search pointer is not larger than a sum of the identified buffer pointer and the specified size associated with the identified buffer pointer, and determining that the search pointer corresponds to the CPU buffer otherwise.

15. The memory management method as claimed in claim 14, wherein the data structure is constructed as a red-black tree, and the largest one of the buffer pointers that is not larger than the search pointer included in the memory access request is identified by performing a binary search on the red-black tree.

16. The memory management method as claimed in claim 13, wherein the address resolution stage further comprises determining whether the memory access request is issued by a process that is authorized to access the device buffer, and denying access to the device buffer if the memory access request is determined to be issued by an unauthorized process.

17. The memory management method as claimed in claim 13, wherein the buffer pointer indicates a starting address of the buffer, an ending address of the buffer, or an offset address corresponding to a fix location of the buffer; and
wherein the search pointer indicates a memory address requested by the application program.

18. The memory management method as claimed in claim 13, wherein the device buffer comprises a graphics processing unit (GPU) buffer, a neural processing unit (NPU) buffer, a vision processing unit (VPU) buffer, a direct memory access (DMA) buffer, or a deep learning accelerator (DLA) buffer; and
each of the one or more accelerator devices comprises a GPU, an NPU, a VPU, a DMA, or a DLA.
